(19) United States
(12) Patent Application Publication
(10) Pub. No.: US 2015/0191660 A1
(43) Pub. Date: Jul. 9, 2015

(54) METHOD AND SYSTEM FOR SEPARATING CATALYST FINES FROM AN OIL STREAM

(71) Applicant: ALFA LAVAL CORPORATE AB, Lund (SE)

(72) Inventor: Mats Englund, Stockholm (SE)

(73) Assignee: ALFA LAVAL CORPORATE AB, Lund (SE)

(21) Appl. No.: 14/408,806

(22) PCT Filed: Jun. 19, 2013
(86) PCT No.: PCT/EP2013/062706

§ 371 Date: Dec. 17, 2014

(30) Foreign Application Priority Data
Jun. 27, 2012 (EP) 12173950.2

(51) Int. Cl. C10G 31/10; C10G 21/16; G01N 24/08; B04B 13/00; C10M 175/00; C10G 21/08; C10L 1/08

(52) U.S. Cl. CPC C10G 31/10; C10G 21/08; C10G 21/16; C10L 1/08; B04B 13/00; C10M 175/0058; G01N 24/08; C10L 2270/026; C10L 2290/544

(57) ABSTRACT

The present invention relates to a method for separating catalyst fines from an oil stream comprising the steps of; separating catalyst fines from an inlet oil stream in a centrifugal separator to generate a stream of purified oil; obtaining an NMR response signal from an NMR apparatus related to the amount of catalyst fines in the purified oil stream and/or the inlet oil stream and initiating the addition of or increasing the amount of separation aid to the inlet oil stream when the NMR response signal indicates an increased amount of catalyst fines in the purified oil stream and/or the inlet oil stream, such as to increase the performance of separating catalyst fines from the oil stream.

### FIELD OF THE INVENTION

The invention relates to a method for separating catalyst fines from an oil stream and a system comprising a centrifugal separator for separating catalyst fines from an oil stream.

### BACKGROUND OF THE INVENTION

Fuel oil for diesel engines on board ships and in power stations contains particles of silicon and aluminium compounds (e.g. microporous aluminium silicates or aluminosilicates known as zeolites), called catalyst fines. Catalyst fines are residues from the refining process of crude oil known as catalytic cracking, wherein long hydrocarbon molecules are cracked into shorter molecules. These particles are undesired in the fuel oil since they are abrasive and may cause wear in the engine and auxiliary equipment. The concentration of catalyst fines in the fuel oil normally varies between 0 and 60 ppm. Catalyst fines are in the size range from 0.1 microns (micrometers) to 100 microns. By conventional cleaning in centrifugal separators catalyst fines down to about 3 microns size may be removed. If the size distribution of the catalyst fines in the fuel oil is such that it contains a lot of smaller particles it may be difficult to clean by conventional methods. Fuel oil (e.g. heavy fuel oil, HFO) is usually stored in large bunkers in harbours or the like. The amount and size distribution of cat fines in the fuel oil may vary from one bunker to another and within one bunker since the particles tend to settle. Due to the settling there may also be a long term build-up of catalyst fines on the bottom of fuel oil bunkers. The amount and size distribution of cat fines may also vary over the content of the fuel tank in direct connection to the engine.

The limit specified in the ISO 8217-2010 for the sum of the aluminium and silicon elements in bunker oil is 60 ppm. It is desirable to reach below 15 ppm at entry into the engine.

### SUMMARY OF THE INVENTION

It is an object of the invention to cope with the above mentioned variations in the quality of fuel oil and to be able to minimize the amount of catalyst fines in the fuel oil in order to reduce the risk of damage on the engine.

Hence, a first aspect of the invention relates to a method for separating catalyst fines from an oil stream comprising the steps of;
separating catalyst fines from an inlet oil stream in a centrifugal separator to generate a stream of purified oil,
obtaining an NMR response signal from an NMR apparatus related to the amount of catalyst fines in the purified oil stream and/or the inlet oil stream,
initiating the addition of or increasing the amount of separation aid to the inlet oil stream when the NMR response signal indicates an increased amount of catalyst fines in the purified oil stream and/or the inlet oil stream, such as to increase the performance of separating catalyst fines from the oil stream.

In embodiments of the invention, the NMR response signal is measured only in the inlet oil stream. In further embodiments, the NMR response signal is measured only in the purified oil stream. However, the NMR response signal may also be measured in both the inlet oil stream and the purified oil stream. The NMR signals may be measured by the same NMR apparatus or by different NMR apparatuses. For example, a first NMR apparatus may be used for measuring the NMR response signal in the inlet oil and a second NMR apparatus may be used for measuring the NMR response signal in the purified oil.

In more general terms, the method may comprise the steps of;
in the centrifugal separator, separating catalyst fines from an inlet oil stream, generating a stream of purified oil,
obtaining an NMR response signal from an NMR apparatus related to the amount of catalyst fines in the purified oil stream,
when the NMR response signal indicates an increased amount of catalyst fines in the purified oil stream, adjusting at least one parameter of the separation process in the centrifugal separator such as to increase the performance of separating catalyst fines from the oil stream.

The at least one parameter may for example be addition of separation aid to the inlet oil stream.

Catalyst fines may be of a hydrophilic nature and it has been found that catalyst fines may be extracted from the fuel oil by a liquid separation aid comprising water or another suitable polar solvent. The separation aid may be selected from the group consisting of water, a water containing electrolyte such as an inorganic or organic acid, a liquid polymer separation aid or combinations thereof. The separation aid should preferably have a poor solubility or be insoluble in the oil. The separation aid is preferably denser than the oil (i.e. having a density larger than that of the oil). The separation aid may be dispersed, i.e. finely divided, in the inlet oil stream, upstream of the centrifugal separator, extracting catalyst fine particles and coalescing into larger drops forming a liquid phase which is denser than the oil (heavy phase). The separation aid may also be mixed with the oil such as to provide a substantial homogenous mixture of oil and separation aid.

The fuel oil from the bunker or fuel tank may already contain water in small amounts, such as less than 0.5% w/w (weight/weight).

The separation aid may be introduced into the oil stream in amounts up to 5% w/w. If a particularly efficient separation aid such as polyethylene glycol is used, the separation aid may be introduced in amounts down to 100 ppm w/w.

In embodiments of the first aspect of the invention, the separation aid is selected from the group consisting of water, a water containing electrolyte such as an inorganic or organic acid, a liquid polymer separation aid or combinations thereof. The organic acid may be a carboxylic acid, preferably a monocarboxylic acid. The organic acid may be a formic acid, acetic acid, propionic acid, butyric acid, oxalic acid, 2-ethyl hexanoic acid or citric acid. The inorganic acid may be a phosphoric, hydrochloric, sulphuric, acetic, benzene sulphonic, or chloroacetic acid.

The liquid polymer separation aid may comprise polymer, or polymer mixture, which is liquid at room temperature and is denser than the oil. The polymer or polymer mixture may comprise a polymer selected from alkylene glycols or polyalkylene glycols based on ethylene or propylene, or copolymers of ethylene oxide and propylene oxide. The separation aid may for example comprise or contain polyethylene glycol (PEG).

As an example, the separation aid may comprise or contain polyethylene glycol having a molecular weight of about 100-300 Daltons. The molecular weight may be the weight average molecular weight (Mw) or the number average molecular weight (Mn).

Thus, the separation aid may be polyethylene glycol having a molecular weight of about 100-300 Daltons or it may be a composition comprising polyethylene glycol having a molecular weight of about 100-300 Daltons.

The liquid polymer may comprise amphifilic polymers having hydrophilic and hydrophobic parts. Thereby a hydrophobic polymer may be modified to provide hydrophilic properties.

The inventor has found that such a separation aid is beneficial for binding catalyst fines, and that combining this with NMR measurements for detecting the amount of catalyst fines is a convenient way of controlling a separation process.

The method may include the step of adding a separation aid to the inlet oil stream, i.e. upstream of the separator.

By means of the NMR apparatus, particles of catalyst fines may be detected in the oil stream even if they are small. Thus the centrifuging process may be properly adjusted to cope with an increasing amount of catalyst fines of smaller size.

There are other various ways of increasing the separation performance in order to enhance the removal of the smaller particles in the oil stream. In particular the parameter of the separation process may be adjusted by decreasing the flow rate of oil through the separator, by increasing the temperature of the oil, or by initiating the addition of or increasing the amount of a separation aid to the inlet oil stream.

Further, in embodiments of the first aspect of the invention, the step of initiating the addition of or increasing the amount of separation aid to the inlet oil stream is preceded by decreasing the flow rate of oil through the separator when the NMR response signal indicates an increased amount of catalyst fines in the purified oil stream and/or the inlet oil stream.

Further, in embodiments of the first aspect of the invention, the step of initiating the addition of or increasing the amount of separation aid to the inlet oil stream is preceded by increasing the temperature of the inlet oil stream when the NMR response signal indicates an increased amount of catalyst fines in the purified oil stream and/or the inlet oil stream. A temperature increase may for example be performed after the flow rate has been decreased.

As an example, the temperature is increased to 90-98° C. Furthermore, the temperature may be further increased to about 110-120° C. before addition of separation aid.

The temperature of the oil may be increased up to a certain optimal temperature limit, such as 98° C., as defined by the separation process. Thus one step may be to ensure that the separation process is performed at the defined optimal temperature. In order to minimise the consumption of the separation aid it is beneficial to, as a first step, decrease the flow rate of oil through the separator, increase the temperature of the oil, and then if this is not sufficient to decrease the amount of catalyst fines in the oil stream, as a second or further step to add or increase the amount of the separation aid.

Thus in embodiments of the invention, method comprises the steps of
separating catalyst fines from an inlet oil stream in a centrifugal separator to generate a stream of purified oil,
obtaining a first NMR response signal from an NMR apparatus related to the amount of catalyst fines in the purified oil stream and/or the inlet oil stream, and if said first NMR response signal indicates that the concentration of catalyst fines is above a first threshold value, then decreasing the flow rate of oil through the separator, and further
obtaining a second NMR response signal from an NMR apparatus related to the amount of catalyst fines in the purified oil stream and/or the inlet oil stream and if said second NMR response signal indicates that the concentration of catalyst fines is above a second threshold value, then increasing the temperature of the inlet oil to about 90-98° C.; and further
obtaining a third NMR response signal from an NMR apparatus related to the amount of catalyst fines in the purified oil stream and/or the inlet oil stream and if said third NMR response signal indicates that the concentration of catalyst fines is above a first threshold value, then initiating the addition of or increasing the amount of separation aid to the inlet oil stream, such as to increase the performance of separating catalyst fines from the oil stream.

The step of obtaining a obtaining a second NMR response signal may further include increasing the temperature of the inlet oil to about 110-120° C. if the NMR response signal further indicates that the concentration of catalyst fines is above the second threshold value after raising the temperature to 90-98° C.

The first, second and third NMR response signals may be obtained by the same NMR apparatus or by different NMR apparatuses. Further, the first, second and third NMR threshold values may be the same or different.

The oil stream from which catalyst fines may be separated may comprise fuel oil for a diesel engine. For example, the inlet oil may be heavy fuel oil (HFO).

Catalyst fines may be separated from the oil stream by supplying a mixture of oil comprising catalyst fines particles and a liquid separation aid into a separation space of a rotating rotor of the centrifugal separator; separating in the separation space the catalyst fines and the liquid separation aid from the oil by centrifugal force; discharging purified oil from the separation space through a central light phase outlet thereof; and discharging separated smaller particles together with separated liquid separation aid from the separation chamber through a heavy phase outlet of the separation chamber, situated radially outside said central light phase outlet. A method of purifying oil in a centrifugal separator is disclosed in EP 1570036 B1. In addition, denser and/or larger particles may be separated from the oil stream and collected at the radially outer portion of the separation space forming a sludge phase. The sludge phase may be discharged intermittently from the separation space by means of a discharge mechanism.

Thus, in the separation process, the following components may be separated from the oil or the oil-separation aid mixture;
a light liquid component mainly comprising the purified oil,
a heavy liquid component comprising water, any added separation aid and smaller catalyst fines, and
a sludge component comprising larger and denser particles (e.g. catalyst fines, sand, wear particles etc.), and a portion of the heavy phase.

In embodiments of the invention, the catalyst fines comprises silicon and/or aluminium compounds. For example, the catalyst fines may comprise particles in the range from about 0.1 microns to about 100 microns. Thus, the NMR response signal may be derived from ²⁹Si and/or ²⁷Al spectra obtained by the NMR apparatus.

A second NMR response signal related to the amount of catalyst fines in the inlet oil stream may be obtained from an NMR apparatus, which may be either a separate NMR apparatus or the same NMR apparatus as previously described. When the second NMR response signal indicates an increased amount of catalyst fines in the inlet oil stream, at least one parameter of the separation process in the centrifugal separator is adjusted such as to increase the performance of separating catalyst fines from the oil stream, as previously described. Thus the system may adopt the separation process to high amounts of catalyst fines in the inlet oil stream. The amounts of catalyst fines in the inlet oil stream and purified oil stream may also be compared to evaluate the separation efficiency and to adjust parameters of the separation process based on the separation efficiency of the catalyst fines.

The invention further relates to a system comprising
a centrifugal separator for separating catalyst fines from an inlet oil stream and for generating a stream of purified oil,
at least one NMR apparatus arranged to generate an NMR response signal related to the amount of catalyst fines in the purified oil stream and/or the inlet oil stream, and
a control unit for initiating the addition of or increasing the amount of separation aid to the inlet oil stream when the NMR response signal indicates an increased amount of catalyst fines in the purified oil stream.

The control unit may be arranged to receive input signals from the NMR apparatus related to the amount of catalyst fines in the oil stream. The control unit may also be arranged to send signal to other units, such as a dosing unit that adds separation aid to the inlet oil stream, a heater that heats the input oil stream, and/or a pump or a flow regulating unit that controls the inlet flow of oil to the separator. Further, the control unit may comprise logical operators that compare the value related to the amount of catalyst fines to predetermined threshold values. Thus, the control unit may comprise a memory and a number of logical functional units. Logical functional units may also be used to finally determine and activate the amount of separation aid that is to be added to the inlet oil. Consequently, the system may comprise a dosing unit for supply of a separation aid to the oil stream on the inlet side of the centrifugal separator, i.e. the inlet oil stream. Thus, the control unit may be adapted for controlling the dosing unit.

Thus, in embodiments of the invention, the means for adjusting may be arranged to adjust at least one parameter when the NMR response signal indicates an increased amount of catalyst fines in the purified oil stream and/or the inlet oil stream and further, the at least one parameter may be adjusted so as to increase the performance of separating catalyst fines from the oil stream.

The centrifugal separator is preferably a disc stack separator which comprises a rotor enclosing a separation space wherein a stack of separation discs is arranged, an inlet for oil to be separated extending into the separation space and a light phase outlet for purified oil extending from the separation space. The centrifugal separator may further comprise a heavy phase outlet extending into the separation space for a liquid phase which is denser than the oil. The centrifugal separator may further comprise discharge ports for a denser particulate phase, a sludge phase, extending from the radially outer portion of the separation space. The separator is preferably configured such that these discharge ports may be opened intermittently, to discharge any sludge collected during the separation process.

The NMR apparatus may comprise means for producing a main magnetic field, a space within said main magnetic field to receive a sample in the form of a portion of the oil stream, a means for exciting a measurable RF magnetization to the sample at an operating frequency defined by said main magnetic field, a means for measuring the RF signal produced by the excited sample, and a means for analyzing the RF signal in order to determine the presence of or amount of catalyst fines in the sample, whereby the apparatus is configured to output a NMR response signal related to the presence of or amount of catalyst fines in the oil stream.

The system may comprise means to control, i.e. measure and/or regulate, the flow rate of oil through the separator, such as by means of flow regulator unit comprising a pump and/or a flow control valve, whereby the processing parameter of the centrifugal separator is adjusted by decreasing the flow rate of oil through the separator. Thus, the control unit may be further adapted to control the flow rate of oil through the separator. For example, the control unit may be adapted to control a flow regulator unit.

The system may comprise an oil heater arranged to heat the inlet oil stream, whereby the processing parameter is adjusted by increasing the temperature of the oil, thus decreasing the viscosity of the oil to enhance the separation performance. Thus, the control unit may be adapted for increasing the temperature of the oil.

The system may comprise means to generate a smaller bypass or bleed-off stream of oil, and wherein the NMR apparatus is arranged to act on the bypass or bleed-off stream of oil.

In embodiments of the invention, the system comprises a second NMR apparatus arranged to generate an NMR response signal related to the amount of catalyst fines in the inlet oil stream, wherein the system is arranged to adjust at least one parameter of the separation process in the centrifugal separator such as to increase the performance of separating catalyst fines from the oil stream when the second NMR response signal indicates an increased amount of catalyst fines in the inlet oil stream.

The NMR apparatus may preferably be arranged downstream of the centrifugal separator, such as in connection with the oil outlet of the centrifugal separator.

As a further aspect of the invention, there is provided the use of a separation aid for binding catalyst fines in an oil stream, wherein the separation aid comprises polyethylene glycol (PEG). The polyethylene glycol may have a molecular weight of about 100-300 Daltons. The inventor has found that such PEGs are useful for binding catalyst fines in an oil stream.

Furthermore, the present invention provides a method for binding catalyst fines in an oil stream comprising
adding a separation aid comprising polyethylene glycol to said oil stream.

As discussed above, the polyethylene glycol may have a molecular weight of about 100-300 Daltons.

### BRIEF DESCRIPTION OF THE DRAWINGS

The invention will be further explained by a description of an embodiment in the following with reference to the accompanying drawing.

FIG. 1 shows a system according to the invention.

### DETAILED DESCRIPTION OF AN EMBODIMENT OF THE INVENTION

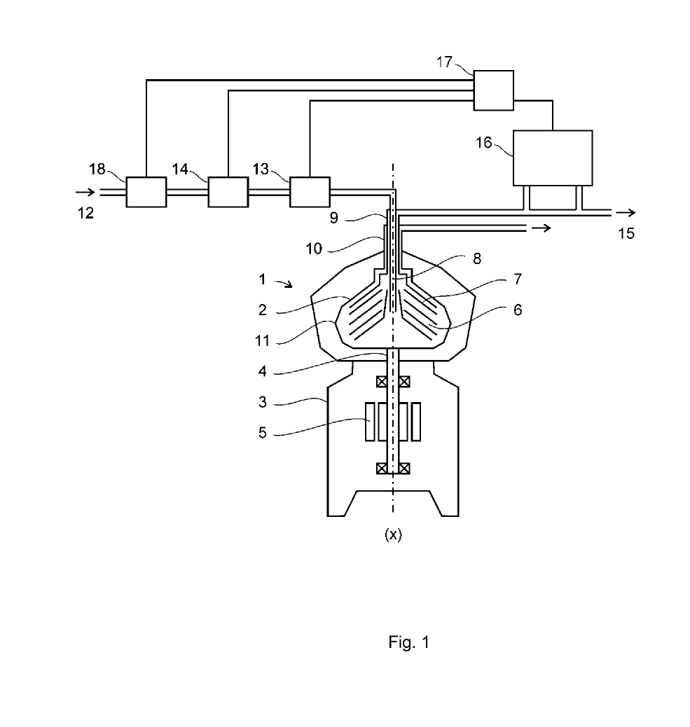

In FIG. 1 a system is shown comprising a centrifugal separator 1 for separating a liquid mixture of components, such as fuel oil contaminated with water and catalyst fines. The centrifugal separator comprises a rotor 2 supported by a spindle 4 which is rotatably arranged in a frame 3 around an axis of rotation (x). The separator comprises a drive motor 5, which may be arranged to drive the spindle in direct connection as shown or indirectly via a transmission such as belts or gears. The rotor forms within itself a separation chamber 6 wherein a stack of frustoconical separation discs 7 is arranged. An inlet 8 extends into the separation space for supply of the liquid mixture to be separated and a light phase outlet 9 for a separated light liquid component of the mixture (i.e. the purified oil) extends from the central portion of the separation chamber. A heavy phase outlet 10 for a separated heavy liquid component of the mixture (e.g. water and separation aid) extends from a portion of the separation chamber situated radially outside the central light phase outlet. A sludge space is formed as a radially outer portion of the separation chamber. The rotor is provided with a discharge mechanism comprising sludge discharge ports 11 extending from the sludge space for intermittent discharge of the sludge phase (e.g. larger solid particles such as catalyst fines) from the separation chamber.

The inlet 9 of the centrifugal separator is connected to a supply line 12 for an inlet stream of fuel oil to be separated. A temperature conditioning unit 13 includes means to measure the temperature of the oil in the supply line and a heater for heating the oil. A dosing unit 14 for a separation aid is connected to the inlet 9 of the centrifugal separator. A flow regulating unit 18 is arranged to control (i.e. means to measure and/or regulate) the flow rate of oil in the supply line.

The light phase outlet 9 of the centrifugal separator is connected to a delivery line 15 for delivery of a stream of purified fuel oil to the engine. The system further comprises an NMR apparatus 16 arranged to obtain a small sample stream of fuel oil from the delivery line. The NMR apparatus is further described below.

The system includes a control unit 17 arranged to receive data from the NMR apparatus and to communicate with the temperature conditioning unit 13, the dosing unit 14 and the flow regulating unit 18.

During operation of the system, a stream of fuel oil to be purified is supplied to the inlet 8 of the centrifugal separator via the supply line 12. A predetermined amount of separation aid is added to and dispersed (i.e. finely divided) in and mixed with the stream of oil by the dosing unit 14. The dosing unit is arranged such that the oil and separation aid mixture is allowed to interact for a period of time before centrifugation in order to increase the extraction of catalyst fines from the oil into the separation aid. The stream of oil and separation aid thereafter enters into the separation chamber 6 of the centrifugal rotor 2 rotating at high speed. The stream of oil is accelerated into rotation and is introduced into the stack of separation discs 7 where it under the influence of centrifugal forces is separated into a light liquid component mainly comprising the purified oil, a heavy liquid component comprising water, any added separation aid and smaller catalyst fines and a sludge component comprising larger and denser particles (e.g. catalyst fines, sand, wear particles etc.). The light liquid component is transported towards the centre of the separation space where it is discharged through the light phase outlet 9. The heavy liquid component is transported radially outwards in the separation chamber and discharged over the top disc and through the heavy phase outlet 10. The sludge component is collected in the sludge space and discharged intermittently to a space outside the rotor by means of the discharge mechanism.

From the purified oil delivery line 15 a small sample stream of oil is diverted and introduced to the NMR apparatus 16. An example of an NMR apparatus is disclosed in US 2012/0001636 A1. During operation of the NMR apparatus, the sample stream is entered into a region of uniform magnetic field. A wire coil and electronic circuits are provided to both apply radio-frequency (RF) pulses to the sample (transmit) and to detect RF signals from the sample (receive). The operating frequency is defined by the nuclei concerned and the magnitude of the main field. In a typical measurement, the atomic nuclei under study in the sample are first allowed to polarize in the magnetic field. Next, one or more RF pulses are applied to the sample with frequencies at or near the resonance frequency at which the nuclei freely precess in the applied uniform magnetic field. The transmit pulses have the effect of tilting the nucleus polarization relative to the direction of the applied field. After the transmit pulse is ended the nuclei precess and create a time-varying magnetic field in the coil. The time-varying field induces a signal voltage in the coil which may be amplified and recorded. In the NMR apparatus, ²⁹Si and/or ²⁷Al nuclei spectra are obtained from the sample by NMR spectroscopy. From these spectra, the total levels of Al and Si in the oil stream can be identified. The zeolites used as catalyst fines typically contain 20-35% of Si and 20-10% Al. Examples of zeolites are ZSM-5 disclosed in U.S. Pat. No. 3,702,886 and U.S. Pat. No. 4,067,724, ZSM-11 disclosed in U.S. Pat. No. 3,709,979, ZSM-12 disclosed in U.S. Pat. No. 3,832,449, ZSM-23 disclosed in U.S. Pat. No. 4,076,842, ZSM-35 disclosed in U.S. Pat. No. 4,016,245, ZSM-38 disclosed in U.S. Pat. No. 4,046,859 and ZSM-48 disclosed in EP 15132. The levels of one of the elements Al and Si and thus the total level of the two elements may alternatively be estimated if the level of the other element is known from the measurements.

When the total level of Al and Si in the sample exceeds a preset threshold value of 5-15 ppm the control unit is arranged to adjust at least one parameter of the separation process in the centrifugal separator such as to increase the separation performance. As a first step the control unit verifies with the temperature conditioning unit 13 that the separation process is performed at the defined optimal temperature, such as 98° C. As a second step the flow regulating unit is instructed to decrease the flow rate of the oil in the supply line. Thereby each flow element of the oil stream is subjected to the centrifugal forces in the separation space during a longer period of time, thus enhancing the separation performance by enabling smaller particles to be separated from the oil stream. As a further process step, if the total level of Al and Si in the sample still exceeds a preset threshold value, the amount of separation aid from the dosing unit is increased to increase the separation performance. When the separation aid, such as water or polyethylene glycol, is added to the oil stream by the dosing unit, it is preferably dispersed in small droplets in the oil stream. Thus the total area of the interface surface between the separation aid and the oil is increased. When catalyst fines particles in the oil come in contact with the separation aid, they are extracted from the oil and into the separation aid. In the separation space of the separator, the fine droplets of separation aid, water from the oil stream and smaller catalyst fines coalesce into larger drops and eventually forms a liquid phase which is denser than the oil (heavy phase). The heavy phase including smaller catalyst fines is discharged through the heavy phase outlet as previously described. By increasing the amount of separation aid in the oil stream, more catalyst fine particles will come in contact with the droplets of separation aid and thus a larger portion of catalyst fine particles will be extracted from the oil stream into the separation aid and separated from the oil stream as a heavy phase.

1. A method for separating catalyst fines from an oil stream comprising the steps of;
separating catalyst fines from an inlet oil stream in a centrifugal separator to generate a stream of purified oil,
obtaining an NMR response signal from an NMR apparatus related to the amount of catalyst fines in the purified oil stream and/or the inlet oil stream,
initiating an addition of separation aid or increasing an amount of separation aid to the inlet oil stream when the NMR response signal indicates an increased amount of catalyst fines in the purified oil stream and/or the inlet oil stream, such as to increase the performance of separating catalyst fines from the oil stream.

2. A method according to claim 1, wherein the separation aid is selected from the group consisting of water, a water containing electrolyte, a liquid polymer separation aid and combinations thereof.

3. A method according to claim 2, wherein the separation aid comprises polyethylene glycol having a molecular weight of about 100-300 Daltons.

4. A method according to claim 1, wherein the step of initiating the addition of or increasing the amount of separation aid to the inlet oil stream is preceded by decreasing a flow rate of oil through the separator when the NMR response signal indicates an increased amount of catalyst fines in the purified oil stream and/or the inlet oil stream.

5. A method according to claim 1, wherein step of initiating the addition of or increasing the amount of separation aid to the inlet oil stream is preceded by increasing a temperature of the inlet oil stream when the NMR response signal indicates an increased amount of catalyst fines in the purified oil stream and/or the inlet oil stream.

6. A method according to claim 5, wherein the temperature is increased to 90-98 C.

7. A method according to claim 6, wherein the temperature is further increased to about 110-120° C.

8. A method according to claim 1, comprising
separating catalyst fines from an inlet oil stream in a centrifugal separator to generate a stream of purified oil,
obtaining a first NMR response signal from an NMR apparatus related to an amount of catalyst fines in the purified oil stream and/or the inlet oil stream, and if said first NMR response signal indicates that the concentration of catalyst fines is above a first threshold value, then decreasing a flow rate of oil through the separator, and further
obtaining a second NMR response signal from an NMR apparatus related to an amount of catalyst fines in the purified oil stream and/or the inlet oil stream and if said second NMR response signal indicates that the concentration of catalyst fines is above a second threshold value, then increasing a temperature of the inlet oil to about 90-98° C.; and further
obtaining a third NMR response signal from an NMR apparatus related to an amount of catalyst fines in the purified oil stream and/or the inlet oil stream and if said third NMR response signal indicates that the concentration of catalyst fines is above a first threshold value, then initiating an addition of separation aid or increasing an amount of separation aid to the inlet oil stream, such as to increase the performance of separating catalyst fines from the oil stream.

9. A method according to claim 1, wherein the NMR response signal is derived from ²⁹Si and/or ²⁷Al spectra obtained by the NMR apparatus.

10. A method according to claim 1, wherein the oil stream comprises fuel oil for a diesel engine.

11. A method according to claim 1, wherein the catalyst fines comprise silicon and/or aluminium compounds.

12. A method according to claim 1, wherein the catalyst fines comprise particles having a size in a range from about 0.1 microns to about 100 microns.

13. A system comprising
a centrifugal separator for separating catalyst fines from an inlet oil stream and for generating a stream of purified oil,
at least one NMR apparatus arranged to generate an NMR response signal related to an amount of catalyst fines in the purified oil stream and/or the inlet oil stream, and
a control unit for initiating an addition of separation aid or increasing an amount of separation aid to the inlet oil stream when the NMR response signal indicates an increased amount of catalyst fines in the purified oil stream.

14. A system according to claim 13, wherein the control unit is further adapted to control a flow rate of oil through the separator.

15. A system according to claim 13, wherein the system comprises an oil heater arranged to heat the inlet oil stream, and wherein the control unit is adapted for increasing a temperature of the oil.

16. A system according to claim 13, wherein the system comprises means to generate a bypass or bleed-off stream of purified oil, and wherein the NMR apparatus is arranged to generate the NMR response signal related to an amount of catalyst fines in the bypass stream of purified oil.

17. A system according to claim 13, wherein the system comprises a second NMR apparatus arranged to generate an NMR response signal related to an amount of catalyst fines in the inlet oil stream, wherein the system is arranged to adjust at least one parameter of the separation process in the centrifugal separator such as to increase the performance of separating catalyst fines from the oil stream when the second NMR response signal indicates an increased amount of catalyst fines in the inlet oil stream.

18. A system according to claim 13, wherein the NMR apparatus comprises means for producing a main magnetic field, a space within said main magnetic field to receive a sample in the form of a portion of the oil stream, a means for exciting a measurable RF magnetization to the sample at an operating frequency defined by said main magnetic field, a means for measuring the RF signal produced by the excited sample, and a means for analyzing the RF signal in order to determine the presence of or amount of catalyst fines in the sample, whereby the apparatus is configured to output a NMR response signal related to the presence of or amount of catalyst fines in the oil stream.

19. (canceled)

20. (canceled)
